(19) United States
(12) Patent Application Publication
(10) Pub. No.: US 2018/0180380 A1
(43) Pub. Date: Jun. 28, 2018

(54) METHODS AND SYSTEMS FOR MANUFACTURING GUN HOLSTER

(71) Applicants: Anthony Joseph CATNER, PLYMOUTH, MI (US); Jamal Nabil HAMKA, PLYMOUTH, MI (US)

(72) Inventors: Anthony Joseph CATNER, PLYMOUTH, MI (US); Jamal Nabil HAMKA, PLYMOUTH, MI (US)

(21) Appl. No.: 15/800,426

(22) Filed: Nov. 1, 2017

Related U.S. Application Data
(60) Provisional application No. 62/439,644, filed on Dec. 28, 2016.

(51) Int. Cl. F41C 33/02

(52) U.S. Cl. CPC F41C 33/0209; B29C 51/10

(57) ABSTRACT

A method for forming a molded article includes the steps of providing one of vacuum molding and press molding. A sheet of thermoformable material which is heated to a temperature at which the material is moldable is provided and the thermoformable sheet is placed over split mold die and vacuum pressure applied or placed between male and female molds on a press mold and pressure is applied. The molded sheet is removed from the dies, and the two halves of the molded sheet are joined together to form a molded article.

### RELATED APPLICATIONS

This application claims priority to U.S. Provisional Application No. 62/439,644, filed Dec. 28, 2016, the contents of which are hereby incorporated by reference.

### BACKGROUND OF THE INVENTION

### Field of the Invention

The present invention relates to methods and systems for accurately manufacturing/molding an object such as a gun holster from a sheet of thermoformable polymeric material.

### Description of the Background Art

Molded polymeric objects including gun holsters are now commonly manufactured from thermoformable polymeric material. While the present invention may be applied in molding various polymeric articles, it is particularly useful in manufacturing weapon holsters. In the holster industry although leather holsters are also common, leather is being replaced by thermoformable material as the material of choice for holsters because it has much better qualities and characteristics than leather. For example, leather holsters are known to be relatively heavy and thick, to absorb moisture, and weapons tend not to be tightly fitted in leather holsters, whereas holsters made of thermoformable materials are lightweight, compact, do not absorb moisture, and when molded properly weapons are nicely fitted thereto with excellent retention.

A typical holster molding process involves heating a sheet of thermoformable material until it becomes soft and pliable; the heated sheet is then molded into a desired shape. Typically, holster manufacturers use either a book press or vacuum forming to achieve this. An actual weapon may be used when molding a holster from the sheet of thermoformable material, but it is also very common to use a replica weapon when molding the holster because it is cheaper, as well as to avoid potential damage to the weapon or other complications. Some replica weapons will typically, closely resemble the corresponding actual weapons in size and shape, but may have certain modifications relating to the trigger, the sight, etc. which make the replica weapons more suitable for molding the holsters. One such replica weapon is known as a “blue gun” because it is molded of blue plastic. Another such replica weapon is manufactured and sold by the present applicant under the mark MULTI MOLDS™.

Another replica weapon is known as a “split mold” or “50/50 mold” and is basically a flat sheet of rigid material such as thermally-resistant plastic having two projections formed thereon which correspond to opposite half sides of a given weapon, and are disposed symmetrically opposite to each other on respective halves of the sheet. The split molds tend to make holsters with greater dimensional accuracy because both half sides of the holster are formed with equal molding pressure, whereas when molding a holster with the blue gun replica weapon the molding pressures applied to the top and bottom sides of the replica weapon may not be equal.

A weapon holder may be formed by using a vacuum forming operation or a press molding operation. The vacuum forming operation is performed using an actual weapon, a replica weapon, or a split mold in molding a holster. A typical vacuum forming operation involves a vacuum table which is connected to a vacuum source. A bottom part of the vacuum forming mold has a flat upper surface with a plurality of openings formed therethrough which communicates with a vacuum chamber within the table; a heated sheet of thermoformable material may be folded around a main portion of a weapon or replica weapon and then placed on the upper flat surface of the bottom half of the mold; a top part of the vacuum forming mold including an elastic sheet of flexible, air-tight material is then placed over the heated sheet of thermoformable material and replica weapon, and also covers all of the openings in the flat surface; the vacuum source is activated so that the elastic sheet and the heated sheet of thermoformable material are drawn by the vacuum very closely over and around the weapon or replica weapon for several minutes until the heated sheet of thermoformable is molded around the weapon or replica weapon and cooled somewhat so that it becomes rigid. The molded thermoformable material is then removed from the vacuum table and will closely resemble the main portion of the replica weapon. Often it is required to heat the sight channel of the molded shell to bring it back to the correct size and shape of the actual weapon. Afterward the molded shell is completed by applying hardware thereto and removing excess portions of the molded thermoformable material.

A press molding operation conventionally utilizes a book press mold that may be hinged or non-hinged, with upper and lower rigid portions having flat faces that may be clamped together. Together with the book press two relatively thick (approximately 1 to 1.5 inches) sections of an elastic foam are used which can withstand the temperatures involved, e.g., 200° F.-500° F., and which will return to their original shapes after each pressing operation so that they may be reused.

In a molding operation, a first section of the foam is laid on the bottom flat surface of the press; a heated thermoformable sheet is folded around a main portion of the weapon, e.g., everything except a portion of the handle, and then placed over the bottom section of foam; a second section of the elastic foam is placed over the replica weapon; and the two portions of the book press are clamped together with suitable pressure for a few minutes to permit the heated thermoformable sheet to be molded into shape around the replica weapon.

The molded sheet is then removed from the foam book press and will closely resemble the main portion of the replica weapon. Some hardware is then added and excess portions of the molded thermoformable material are removed to complete the holster. If a split mold replica weapon is used, the molding process is similar except that the heated sheet is simply placed over the split mold before being clamped and molded, and after the thermoformable sheet is molded and removed from the press mold, the molded sheet is folded one half over the other and the halves are joined together such that the recesses formed therein are disposed opposite to each other, excess portions of the molded sheet are removed and hardware is then added to complete the holster.

While these conventional methods are generally suitable and appropriate for making the holsters from the thermoformable plastics, they remain to be improved in several respects.

With the both the vacuum forming method and book press mold, the manufacturing tolerances are relatively large and resulting holsters may not closely match the specific details and shapes of the replica weapons, and correspondingly may not perfectly match the size and shape of the actual weapons which to be fitted therein. Good definition is important for weapon holsters because it gives the holsters a better, more appealing appearance and better fitment for a weapon as holstered therein. Further, there is typically a significant amount of excess which must be trimmed/removed from the molded holster, which is inefficient in terms of material costs and production efficiency. Still further, the operations as described above take a relatively long time, and hence production efficiency could be improved.

### SUMMARY OF THE INVENTION

The present invention addresses the above deficiencies, and provides methods and systems for making a molded article with speed and accuracy. While the invention may be applied in molding a variety of articles, the present invention also provides new methods and systems for accurately manufacturing/molding a gun holster from thermoformable plastic such as acrylic polyvinyl chloride or similar polymeric compositions, sold for example under the trademarks KYDEX®, HOLSTEX®, BOLATRON™. Other similar thermoformable plastics may be utilized as well. The methods and systems according to the present invention are much more efficient than the conventional methods and systems, and also can be used to manufacture holsters or other articles with greater precision than has been previously possible.

According to one embodiment of the invention, there is provided a vacuum forming method for manufacturing an article from a thermoformable plastic which involves the use of a modified split mold die and a modified vacuum table. The modified split mold die when used for a weapon holster includes two separate halves of a replica weapon with planar back surfaces that mate together. The split mold die is different from a conventional apparatus in which the split mold is a single member with the two halves adjoined side-by-side in a planar disposition with a flat section of the mold disposed between and connecting the two halves.

In this embodiment of the present invention, at least one of the two halves of the split mold die has a recess defined in the planar back surface thereof into which an insert or boss (hereinafter “insert”) may be fitted such that the insert projects from the planar back surface of the half and may be fitted into another recess defined in the surface of a vacuum molding table so that the split mold half will be precisely positioned on the vacuum table. The other half may be similarly formed with a recess into which another same size insert may be fitted while projecting from the planar back surface of the mold half, and the vacuum table may have another recess defined in the surface thereof so that the projecting insert on the other half may also be fitted thereto for precisely positioning the other half on the vacuum table. Alternatively, the other half may be formed with a projection or boss provided on its back surface that is shaped to be fitted in a recess defined in the surface of the vacuum molding table, as well as to be fitted into the recess defined in the back surface of the one half.

The modified vacuum table may have two inserts provided thereon or adhered thereto which are shaped or sized to mate with the recess or recesses defined in the split mold halves, or may have recesses formed therein which are configured to receive inserts for mating with recesses in the two halves of a split mold. When fitted to the vacuum table surface, the two halves of the split mold are precisely positioned relative to each other with a specified gap between opposing sides of the two halves. The size of the gap precisely corresponds to the size and shape of a channel formed into the holster for receiving a gun sight of a gun fitted into the holster.

A forming operation may include the steps of: fitting two mold halves of an object to the vacuum table surface using the inserts that fit partially into recesses formed in the vacuum table surface and partially into recesses formed into the recesses formed into the back surfaces of the split mold halves with a gap between the two halves that will become a fold line; heating a thermoformable sheet to a moldable temperature; placing the heated sheet over the two mold halves on the vacuum table, preferably such that all vacuum openings in the vacuum table surface are covered by the heated sheet; applying a vacuum to the vacuum table so that the heated sheet is drawn into close engagement with the split mold halves and with the table surface so that sheet is molded over the split mold halves (and partially cooled); removing the molded sheet from the vacuum table together with the split mold halves; folding the molded sheet one half over the other while the split mold halves are disposed in respective cavities defined in the molded sheet until (the planar) back surfaces of the split mold halves are engaged together with one of the inserts secured between the recesses formed in the (planar) back surfaces; and then pressing the folded halves of the molded sheet closely together against the split mold halves disposed there between, including along fold line, which remains heated, so that the recesses formed in the molded sheet closely assume the shape of the object to give final detail to the molded sheet; and then removing the split mold halves from the molded sheet.

In this process, unlike conventional vacuum molding, no flexible membrane is applied over the heated thermoformable sheet, because the thermoformable sheet is sufficiently attracted to the mold by application of the vacuum. Also, the split mold or weapon remains together with the molded sheet until after the sheet is folded in half along the heated fold line.

Additionally, the split mold halves advantageously serve a dual purpose in the manufacturing process, i.e., first the split mold halves are used together with the vacuum table for molding the sheet of thermoformable material such that the sheet has two recesses formed therein corresponding to the mold halves, and second the split mold halves are then joined together as a replica weapon which is used when the molded sheet one half over the other in forming the holster from the molded sheet.

This dual function provides multiple advantages. For example, it reduces the number of components required for producing the holster or other object, noting that in the conventional manufacturing process for forming a holster or other object using a split mold it is necessary to use a replica weapon or actual weapon, different from the split mold, when folding the halves of the molded thermoformable sheet onto each other, whereas the split mold according to the present invention also functions as a replica weapon when folding the halves of the molded thermoformable sheet onto each other.

Also, the method of present invention is significantly faster than the conventional process involving a split mold and provides a much greater precision and accuracy of detail in the finished product than is possible via the conventional method using two different molds for the vacuum forming and folding steps. The process of the invention is significantly faster because the split mold halves remain with the molded sheet and are brought together to define the replica weapon simultaneously as the molded sheet is folded in half, whereas in the conventional process separate steps are involved in removing the folded sheet from the vacuum table, and carefully fitting a replica weapon or real weapon between the folded halves of the molded sheet.

Also, the molded sheet remains heated at an appropriate temperature for folding and final pressing because fewer steps are required, so that it becomes possible to eliminate any need for reheating the molded sheet, as is typically necessary with the convention process. The resulting holster or other object has a much greater precision and accuracy of detail because the same mold (split mold) is used in the vacuum molding and the folding final pressing steps for exact consistency, whereas in the conventional process involving two different molds, there is inevitably some amount of inconsistency. The formed holster may then be fitted to a trim mold to remove any excess thermoformable sheet material from the molded item.

In an alternative embodiment, there is provided a method for manufacturing a weapon holster from a thermoformable plastic which utilizes a book press, the method comprising providing a press having an upper portion and a lower portion which may be selectively moved towards and away from each other; and providing a matched set of a male and female dies, the female die having a recess defined therein having a shape and size which correspond to a given object, and the male die having a projection which is sized and shaped to closely mate with and fit into the recess of the female die. A heated sheet of thermoformable plastic material is disposed between the male and female dies, and the heated sheet is molded by clamping together the male and female dies between the upper and lower portions of the press. The male and female dies may be constructed of any appropriate temperature-resistant, rigid material including metals and plastics which will not be affected by a heated sheet of the thermoformable material which is placed and molded therebetween.

The method may further comprise a step of folding half of the molded sheet across the other half of the molded sheet so that the recess in the female die and the projection in the male die of the given object are opposed to each other, and fastening the folded halves of the sheet together. This step of folding the molded sheet of thermoformable is made possible by the enhanced molding precision that is achieved with the press method according to the invention. In one preferred embodiment the molded item is a weapon holster.

### BRIEF DESCRIPTION OF DRAWINGS

FIG. 1 is a front perspective view of two halves of a split mold die according to an exemplary embodiment of the present invention.

FIG. 2a is a perspective view of the back portions of each half of the split mold die according to an exemplary embodiment of the present invention.

FIG. 2b is a perspective view of a back portion of a split mold according to an exemplary embodiment of the present invention.

FIG. 3a is a top plan view of a vacuum table according to an exemplary embodiment of the present invention.

FIG. 3b is a top plan view of a vacuum table adapter plate according to an exemplary embodiment of the present invention.

FIG. 4 is a perspective view of the split molds joined together according to an exemplary method of the present invention.

FIG. 5a is a top plan view of the molded thermoformable sheet obtained according to an exemplary method of the present invention.

FIG. 5b is a perspective view of the molded article obtained according to an exemplary method of the present invention

FIG. 6 is a perspective view of a press for forming a molded form according to an exemplary method of the present invention;

FIG. 7 is a plan view of a matched set of male and female dies attached to a press according to an exemplary method of the present invention.

FIG. 8 is a top plan view of a molded sheet formed according to an exemplary method of the present invention.

FIG. 9 is a top plan view of a trim die according to an exemplary method of the present invention.

### DETAILED DESCRIPTION

The present invention addresses the above described deficiencies of conventional methods for molded articles such as holster making methods, and provides a new method and system for accurately manufacturing/molding articles, such as but not limited to gun holsters, from thermoformable materials, which is much more efficient than the conventional methods, and which also manufactures articles with greater precision than has been previously possible.

According to one embodiment of the invention, there is provided a vacuum forming method for manufacturing a weapon holster from a thermoformable plastic which involves the use of a modified split mold and a modified vacuum table.

Preferred thermoformable plastics for use in the method of the present invention are acrylic-polyvinyl chloride composite materials, sold under the trademarks KYDEX®, HOLSTEX®, and BOLATRON™, or any other similar thermoformable material.

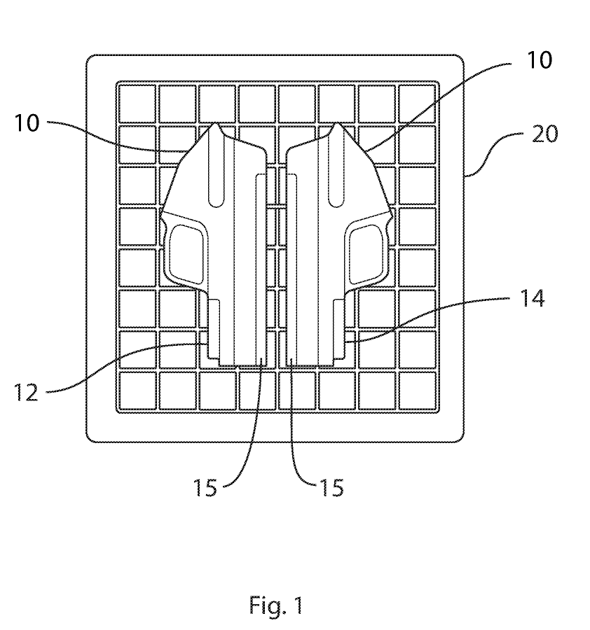

FIG. 1 depicts a modified split mold die 10 according to an exemplary embodiment of the present invention which includes two separate halves 12, 14, of a replica weapon with planar back surfaces that mate together. A groove or recess 15 is precisely formed, e.g., by machining, on each half of the split mold, and the grooves of each half align exactly, upon completion of the molding process. As shown in FIG. 1 the split mold die is mounted on a vacuum table 20.

The split mold is different from a conventional apparatus in which the split mold is a single member with the two halves fixed side-by-side in a planar disposition with a flat section of the mold disposed between and connecting the two halves. The split mold may be formed by pouring a resin material or by a computer numeric control process and may be made from materials such as, but not limited to, aluminum infused resin, aluminum acrylic, epoxy or HDPE.

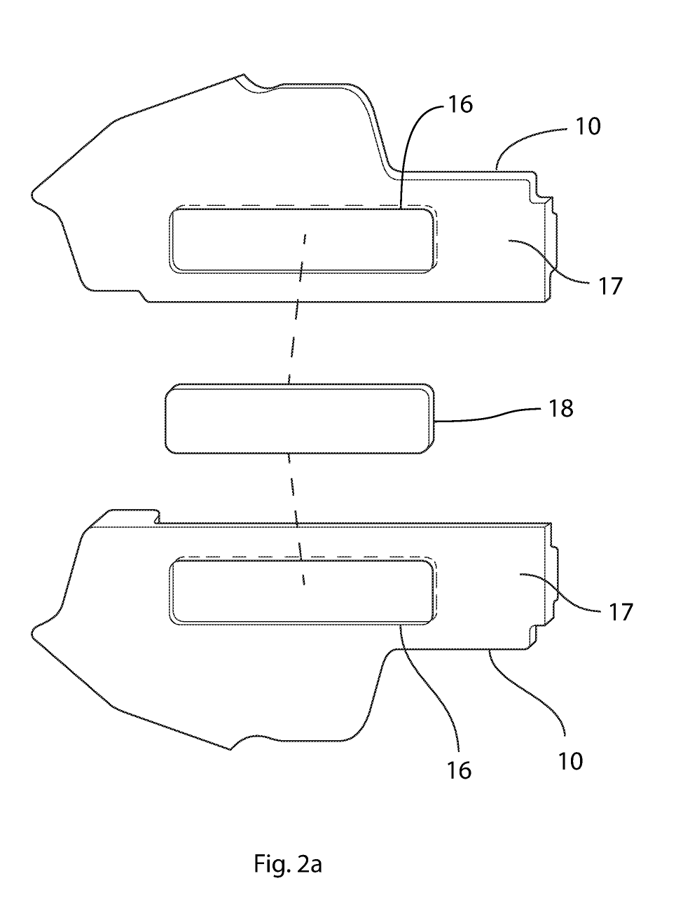

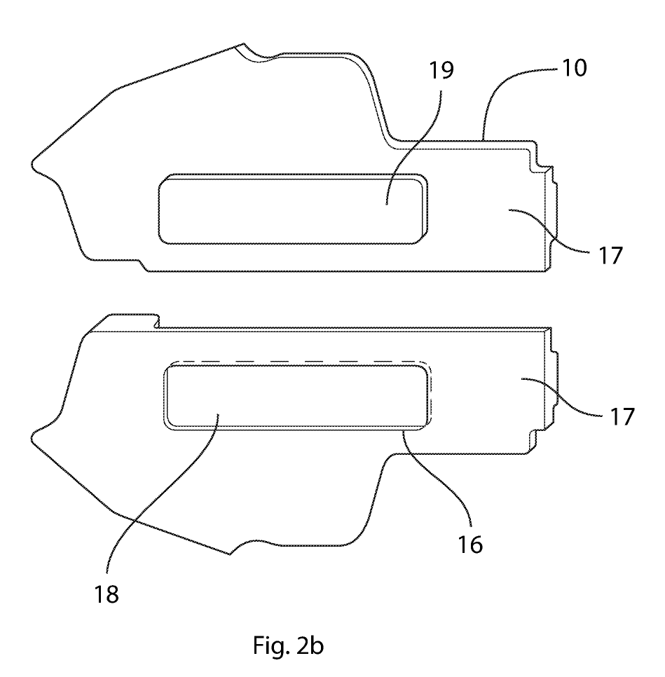

As shown in FIG. 2a, at least one of the two halves of the mold die 10, 10, may have a recess 16 defined in a back surface thereof into which a removable insert 18 may be fitted such that the insert projects from the planar back surface of the half, e.g., the insert may have a thickness which is twice the depth of the recess. The other half of the mold die may be similarly formed with a recess of the same size and shape into which another same size insert may be fitted.

Alternatively, as shown in FIG. 2b one half of the mold die may be formed with a projection 19 molded or otherwise provided on its back surface 17 is fitted into the recess 16. The projection or projection portion of the insert has the same size and shape as the recess, as the projection or insert is fitted into the recess. As shown in FIG. 2a, the projecting portion of the insert 18 or the projection 19 shown in FIG. 2b must closely fit in the recess of the other half of the die without any play when manufacture of the molded article is completed, as discussed further herein.

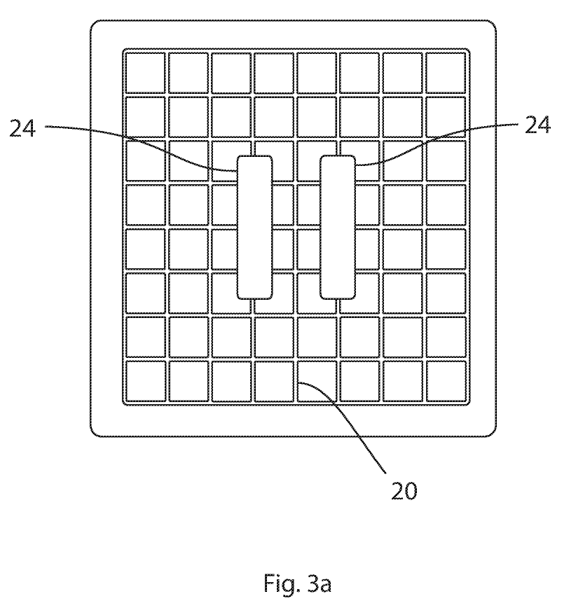

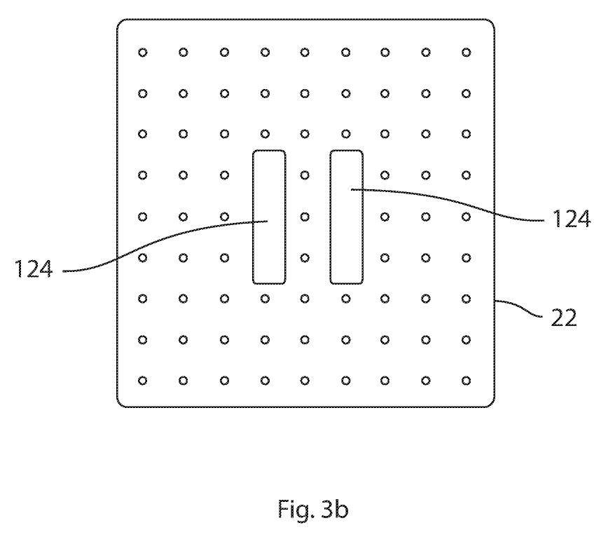

As shown in FIG. 3a, a vacuum table 20 according to an exemplary embodiment of the present invention may have two recesses 24, 24, formed in an upper surface thereof which will support the split mold die halves thereon during a molding operation. The recesses are shaped and sized to receive two inserts 18, 18, shown in FIG. 2a, or to receive one insert 18, and one projection 19 on the back of one die half shown in FIG. 2b, so that the two mold halves may be precisely positioned relative to each other on the vacuum table with a gap between opposing sides of the two halves as shown in FIG. 1. The gap is precisely sized and shaped because the portion of the molded sheet of thermoformable material which fills such gap becomes a living hinge when the molded sheet is subsequently folded one half upon the other and closely pressed against a replica object or replica or real weapon during the manufacturing process as discussed further herein.

Noting that many vacuum tables already exist which do not have the recesses formed in an upper surface thereof, it is also possible to retro-fit an existing vacuum table with an adapter plate having such recesses formed therein, such as the adapter plate 22 shown in FIG. 3b. The adapter plate also includes two recesses 124, 124 formed in an upper surface thereof which will support the split mold die halves thereon during a molding operation.

As shown in FIG. 3a, the vacuum table may have a pattern of many openings defined through and/or recesses defined in an upper wall thereof in spaced relation to each other fully across the entire area of the upper wall so that a vacuum may be drawn through the openings and/or recesses during a vacuum molding operation. It is important that a sufficient amount of vacuum be drawn through the upper wall in an area below the split mold haves so that a heated sheet of thermoformable material may be closely/tightly drawn against the split mold halves during the molding operation. For such purpose, an increased number of vacuum openings may be defined in an area between where the two mold die halves are fitted to the vacuum table and/or a vacuum source may be connected to the vacuum table near to where the two mold die halves are fitted to the vacuum table.

In this embodiment it is important that the two inserts or the one insert and one projection, as well as the corresponding recesses, have a sufficiently large size, but non-complicated shape because this permits the projection, or the projecting portion of an insert as disposed in the recess, on the back surface of one of the split mold die halves to be quickly and accurately fitted into the recess on the back surface of the other split mold die halves (thereby forming a replica weapon or other object) simultaneously as one half of a molded thermoformable sheet is folded onto the other half of the molded sheet while the split mold die halves remain in the recesses defined in the molded sheet during the manufacturing process according to the exemplary embodiment of the present invention. Such fitting of the split mold halves together simultaneously as one half of a molded thermoformable sheet is folded onto the other half of the molded sheet would not be possible if, for example, each of the die halves had multiple smaller and/or more complicated-shaped recesses that received a corresponding number and/or shaped of projections when fitting the halves together.

Instead, the die halves having multiple smaller and/or more complicated-shaped recesses would have to be fitted together while they were separated from the molded sheet, and then the joined halved would be subsequently placed between the folded halves of the molded sheet. Also, the relatively large size of the inserts, projection, and recesses assures that the split mold die halves remain stably and non-movingly joined together as a replica weapon or other object while the molded sheets of thermoformable material is folded around and pressed closely against the joined halves during the manufacturing process. In the exemplary embodiment the inserts, projection, and recesses have an area which is approximately 1/10-¼ of the area of the back surface of the corresponding split mold die half.

While the inserts may be made of any appropriate material, if they are made of steel or other metal which is attracted by magnetic force, magnets may advantageously be disposed on a face of a molded sheet of thermoformable material opposite to the split mold die halves such that the magnets will attract the inserts, and thereby help to maintain one or both of the split mold die halves in the recesses of the molded sheet as the sheet is folded in half around the die halves.

Again, another advantage of the present invention is that the vacuum table does not require the conventional, flexible membrane to be placed between the thermoformable sheet and the molds.

The forming operation includes the steps of fitting the mold die halves 12, 14, (split mold), to the vacuum table 20 as shown in FIG. 1, using the insert 18 on the back of one or both mold die halves, or one insert 18 in one mold half and one projection 19 in the other mold half, into recesses 16, 16, formed into a surface of the vacuum table 20 as shown in FIG. 3a. A thermoformable sheet (not shown) having a thickness of 0.08 to 0.095 inches is heated to a moldable temperature. Generally, in the step of heating the sheet of thermoformable plastic material, the material is heated to a temperature of from 300° F. to 500° F. The heated sheet is placed over the two mold halves on the vacuum table. Optionally, a ring or square (not shown) is placed over the periphery of the thermoformable sheet and downward pressure is applied to force the periphery of the thermoformable sheet against the vacuum table surface. The vacuum is initiated to form the molded article.

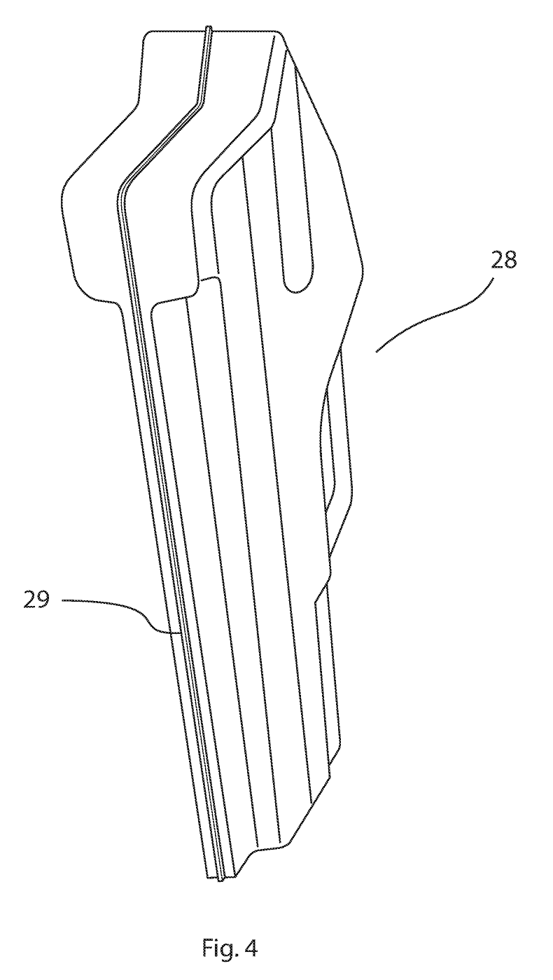

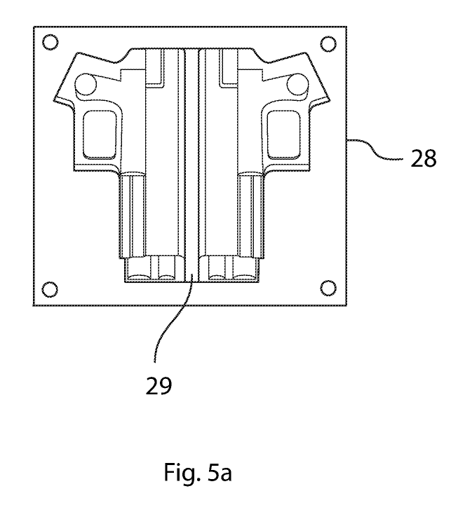

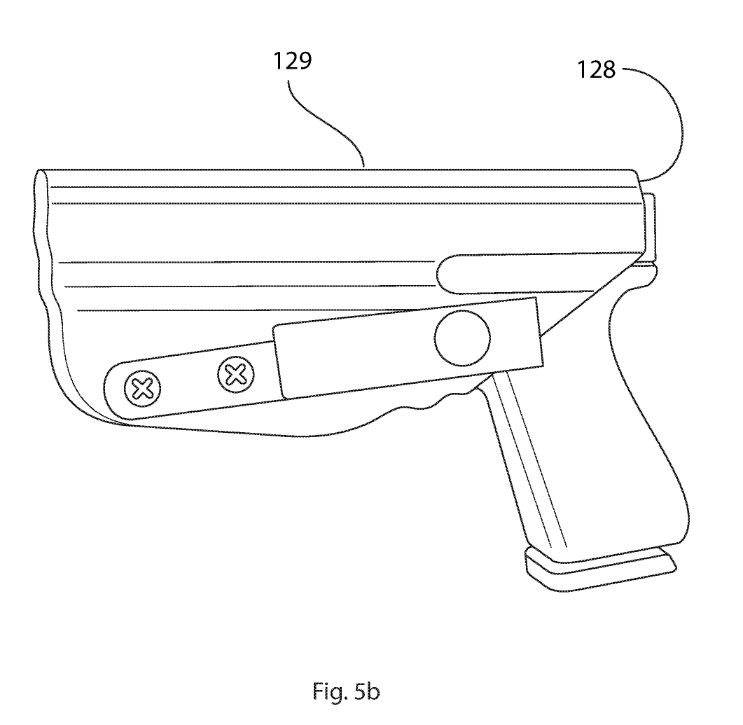

The two halves of the split mold dies 12, 14 are removed from the vacuum table 20 together with the molded sheet of thermoformable material and the split mold dies are simultaneously fitted together as shown in FIG. 4, and the molded sheet is folded one half onto the other as discussed above. The molded thermoformable sheet 28 shown in FIG. 5a is folded along the still heated center portion 29 of the sheet, or living hinge, and then the folded halves of the molded sheet are pressed closely together against the joined die halves still disposed there between, including along the still heated living hinge fold line so that the folded portion closely assumes the shape of the replica weapon or other object defined by the combined split mold die halves to give final detail to the object being molded from the sheet of thermoformable material.

When cool, the joined die halves are removed from the molded object, and may be reused in other molding operations. As shown in FIG. 5b when the molded object is a weapon holster 128, the fold line 129 or living hinge advantageously forms a sight line. As shown in FIG. 5b, the sight line 129 of the weapon is a precise replica of the site line of the weapon, again, based on the precise size and shape of the gap between the mold die halves as fitted onto the vacuum table.

This process eliminates the step of applying a flexible membrane over the heated thermoformable sheet, as is done in conventional vacuum molding, because the thermoformable sheet is sufficiently attracted to the mold by application of the vacuum.

The vacuum table is specially modified so that the portion of the thermoformable sheet between the two molded halves (corresponding to the gap between the actual two halves as mounted on the vacuum table), remains heated and flexible while the rest of the sheet is cooled and becomes rigid.

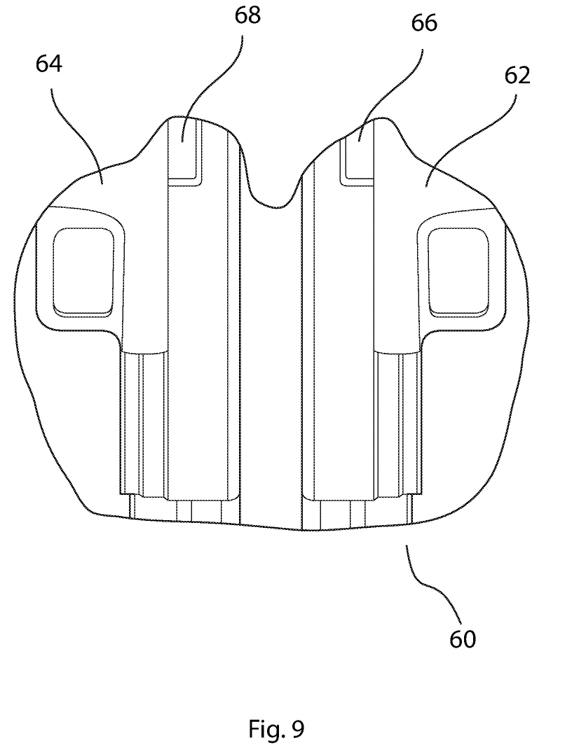

Optionally, a trim mold such as shown in FIG. 9 may be used to remove any excess material from the molded article. The trim die shown in FIG. 9 comprises two halves 62, 64 configured in the shape of the molded halves of the molded sheet to receive and securely hold the molded sheet of thermoformable plastic material after the molded sheet is removed from die molds. Once secured to the trim die, excess material can be trimmed from the molded sheet using a tool such as a router (not shown) so that the resulting article, in this case the holster, will have a compact aesthetic appearance.

The vacuum table is modified from a conventional vacuum forming table to provide maximum amount of vacuum at the gap between the opposing split mold halves as mounted on the vacuum forming table in order for the portion of the sheet over the gap between the molds to be pulled close to the vacuum forming table to give good definition to the opposing surfaces of the recesses formed into the sheet which face the gap.

While this promotes cooling of the gap portion of the molded sheet additional modifications to the vacuum forming table address this issue. The table may be modified to include several openings along the length of the gap. Additional multiple openings may be located to provide stronger vacuum on the portions of the thermoformable sheet that is molded into the recesses over the two split mold halves.

Additionally, during the vacuum molding step, wet towels or cool water may be applied to the portion of thermoformable sheet that is molded into the recesses over the two split mold halves so that these portions are cooled more quickly via heat exchange between the heated plastic and the water.

The present invention provides an advantage in that the same split mold die is used when initially forming the heated thermoformable sheet on the vacuum table and when subsequently folding the halves of the molded thermoformable sheet onto each other. Additionally, the folding is done immediately after the molding step. The present invention is also more efficient because it eliminates the step of applying a covering membrane between the thermoformable plastic sheet and the mold.

The method of present invention provides much greater precision and accuracy of detail in the finished article. When the article is a holster, the present invention improves detail results especially along the folded portion that corresponds to the site line, over that possible via the conventional method which uses different molds for the vacuum forming and folding steps.

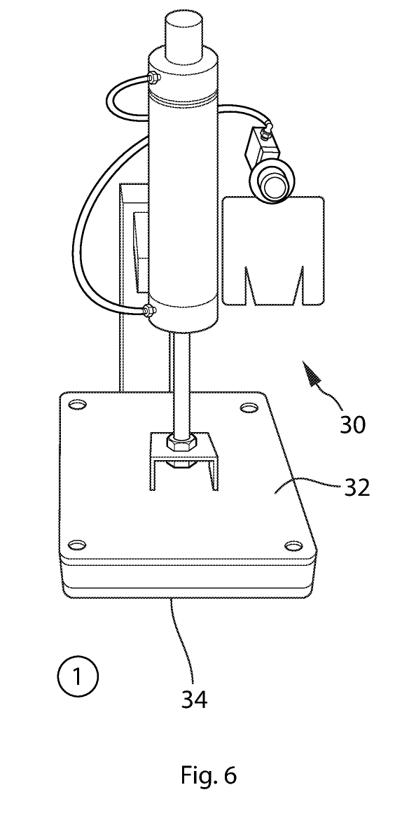

In an alternative embodiment, there is provided a press molding method utilizing a book press, for manufacturing a molded item from a thermoformable plastic. As shown in FIG. 6, a press 30 having an upper portion 32 and a lower and a lower portion 34 which may be selectively moved towards and away from each other is provided.

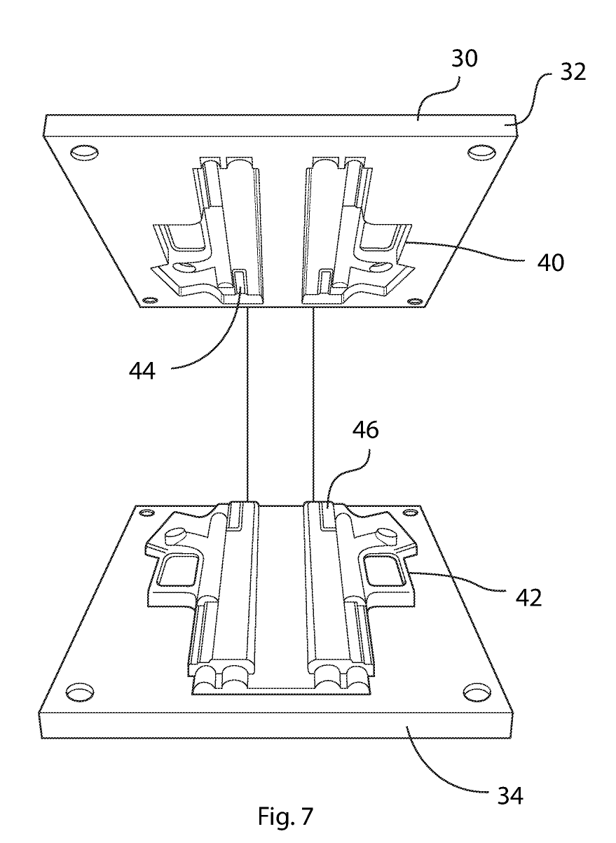

As shown in FIG. 7 matched set of a female and male dies or molds, 40 and 42 respectively is provided one to the upper portion 32 and one to the lower portion 34 of the press 30. The female die 40 has at least one recess 44 defined therein. The male die 42 has at least one corresponding projection 46, formed thereon, which is sized and shaped to closely mate with and fit into the recess of the female die.

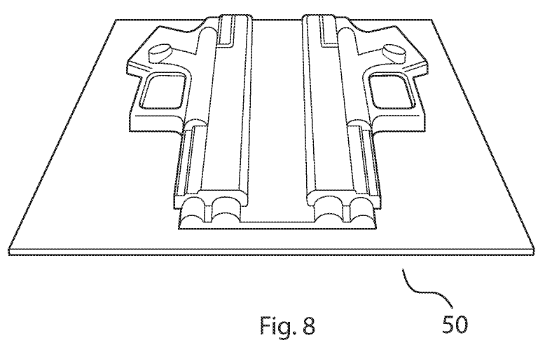

Alternatively, each die may include a recess, wherein an insert is provided in the male molded portion for insertion into the recess of the female molded portion. A heated sheet of thermoformable plastic material (not shown) is disposed between the male and female dies and the male and female dies are clamped together between the upper and lower portions of the press, and pressure is applied to mold the heated sheet of thermoformable plastic material to the die shape and form a molded thermoformable sheet 50, as shown in FIG. 8. The male and female dies may be constructed of any appropriate temperature-resistant, rigid material including metals and plastics which will not be affected by a heated sheet of the thermoformable material which is placed and molded therebetween.

The method further comprises a step of joining the two molded forms so that the recess corresponding to the female half of the molded object is mated with the projection on the male half of the molded object. In a preferred embodiment the molded article is a weapon holster.

This step of folding the molded sheet of thermoformable material is made possible by the enhanced molding precision that is achieved with the press method according to the invention, whereas in the previously existing book press method it has been necessary to separate the two halves of the molded sheet so that the halves could be properly aligned with each other. Of course, the process according to the present invention may involve separating the molded sheet into two portions which respectively include the recesses corresponding to those in the two halves of the given weapon; and joining the two portions of the molded sheet together but this is less efficient than the folding step.

As shown in FIG. 9, the method may further comprise providing a trim die 60 which comprises two halves 62, 64 configured in the shape of the molded halves of the molded sheet to receive and securely hold the molded sheet of thermoformable plastic material after the molded sheet is removed from the male and female dies. The trim die includes one of a recess 66 and a projection 68 with a shape and size closely corresponding to an impression molded into the molded sheet of thermoformable material, and means for fixing the molded sheet of thermoformable material to the recess or projection of the trim die such that the impression of the molded sheet is secured in engagement with the recess or projection of the trim die, and whereby the molded sheet may be quickly and accurately trimmed of any excess material. In the depicted embodiment of FIG. 9, the article is a gun holster. Once secured to the trim die, excess material can be trimmed from the molded sheet using a tool such as a router (not shown) so that the resulting article, in this case the holster, will have a compact aesthetic appearance.

The method of manufacturing the molded item, when it is a weapon holster, may also utilize an actual or replica weapon to form the male and female dies. Once the dies are formed, these provide the necessary shape and definition to the holster without any further use of the replica weapon. The same is true of any other article used to form the mold to be used for the method of the present invention.

According to an important aspect of the present invention, a plurality of the matched sets of unitary die sets will be prepared in advance which correspond to various weapons or weapon models, respectively. With the plurality of die sets, the method can be efficiently used to manufacture a plurality of holsters for different weapons by simply securing the appropriate die to the press at the beginning of the molding operation.

What is claimed is:

1. A method for forming a hollow molded article comprising:
providing one of i) a vacuum molding apparatus having a vacuum plate with recesses formed therein, and ii) a press molding apparatus having an upper plate and an opposing lower plate, moveable toward and away from each other;
providing to the molding apparatus one of
a) a split mold die having separate halves, the halves being matable with each other, wherein each die comprises a recess for receiving an insert or projection, wherein the insert or projection is the same size as the recess; and
b) a set of joined matable dies comprising two joined halves, the first half having at least one recess for receiving an insert or projection, and the second half having a projection formed thereon, the projection or insert being sized and shaped to closely mate with and fit into the recess of the first half;
heating a sheet of thermoformable plastic material to a temperature at which the material is moldable to form a heated sheet;
applying the heated sheet of thermoformable plastic material to one of the split mold and the matable joined die halves dies;
securing one of the split mold matable dies and the joined matable dies to the molding apparatus, placing a heat resistant thermoformable sheet thereover;
applying vacuum or pressure to the molding apparatus to form the thermoformable sheet into the molded article: and
removing the molded thermoformable sheet from the mold.

2. The method of claim 1, wherein the method further comprises a step of
providing a trim die which is configured to receive and securely hold the molded sheet of thermoformable material following its removal, the trim die having one of a recess and a projection with a shape and size closely corresponding to an impression molded into the molded sheet of thermoformable material and providing a pattern for trimming the molded sheet;
providing a means for fixing the molded sheet to the trim die, such that the impression of the molded sheet is secured in engagement with the recess or projection of the trim die; and
trimming excess material from the molded sheet using the trim die.

3. The method of claim 1, wherein the thermoformable material is an acrylic-polyvinyl chloride composite material.

4. The method of claim 1, wherein in the step of heating the sheet of thermoformable material, the material is heated to a temperature of from 300° F. to 500° F.

5. The method of claim 1, wherein the molded article formed thereby is a gun holster.

6. The method of claim 1, wherein the joined mold die halves are provided on the vacuum mold apparatus.

7. The method of claim 6 further comprising:
mating together the two halves of the die by inserting the projection or insert of one die into the recess of the other die to form a unitary die,
placing the unitary die into one half of the molded sheet,
folding the molded sheet along a central heated portion so that the other half of the sheet is fitted to the other half of the unitary die, and allowing the mold to cool,
removing the molded sheet from the dies, and
joining the two halves of the molded sheet together.

8. The method of claim 7, wherein the molded article is a gun holster and a site line is formed at the fold line of the molded sheet.

9. The method of claim 1, wherein the step of providing a joined matable die further comprises providing a plurality of joined matable dies corresponding to different weapons.

10. The method of claim 1, wherein the press is selected from one of a manual press, a hydraulic press and a pneumatic press.

11. A method for forming a hollow molded article comprising:
providing a vacuum molding apparatus having recesses formed therein,
providing to the molding apparatus a split mold matable dies in separate halves, the die halves being matable with each other, at least one die half having a recess defined in a back surface thereof for receiving an insert or projection, and an other die half having one of a recess defined in a back surface thereof for receiving an insert, or a projection formed in said back surface for insertion into the recess of the one half, wherein the insert or projection are the same size as the recess;
securing the split mold matable dies to the molding apparatus by means of the insert or projection;
heating a sheet of thermoformable plastic material to a temperature at which the material is moldable to form a heated sheet;
applying the heated sheet of thermoformable plastic material to the split mold dies;
applying vacuum to the molding apparatus to form a molded article on a single thermoformable sheet;
joining together the halves of the split mold dies to form a unitary die;
folding the molded sheet over the unitary die;
allowing the molded sheet to cool; and
removing the die from the molded sheet.

12. The method of claim 11, wherein the split mold die halves are aligned along a vertical axis, adjacent to each other on the vacuum molding apparatus.

13. The method of claim 12, wherein each half of the split mold die includes a groove precisely machined in each half, and the grooves of each half align exactly when the split die is formed into a unitary die.

14. The method of claim 13 further comprising:
mating together the two halves of the split mold die by inserting into the recess of the one die the projection or insert of the other die to form a unitary die,
placing the unitary die into one half of the molded sheet,
folding the molded sheet along a central heated portion so that the each half of the molded sheet is fitted to half of the unitary die, and
allowing the molded sheet to cool to form a molded article.

15. The method of claim 14, wherein the molded article is a gun holster and a site line is formed at the fold line of the molded sheet and includes the feature of the machined grooves in the split mold die.
